(19) United States
(12) Patent Application Publication
(10) Pub. No.: US 2009/0018877 A1
(43) Pub. Date: Jan. 15, 2009

(54) System and Method for Modeling Business Processes

(75) Inventors: Christopher Raymond Houck, Dallas, TX (US); Edward M. Peters, Dallas, TX (US); Stuart H. Burris, JR., Garland, TX (US); Eric P. Armstrong, McKinney, TX (US)

Correspondence Address: BAKER BOTTS L.L.P., 2001 ROSS AVENUE, SUITE 600, DALLAS, TX, 75201-2980, US

(73) Assignee: Openconnect Systems Incorporated, Dallas, TX (US)

(21) Appl. No.: 11/775,609

(22) Filed: Jul. 10, 2007

(51) Int. Cl. G06Q 99/00

(52) U.S. Cl. 705/7

(57) ABSTRACT

According to one embodiment of the disclosure, a computerized method for modeling business processes includes receiving, at a computer, interaction data for interaction sessions. The interaction data includes session states indicative of session screens. The interaction data further includes transitions between the session states. The computerized method also includes identifying, at the computer, business processes based on the interaction data. The computerized method further includes identifying, at the computer, instances of the business processes in the interaction data. The computerized method further includes storing the instances as event records. The event records include a parameter indicative of a corresponding business process. The computerized method further includes generating a model based on the event records.

### TECHNICAL FIELD

This disclosure relates generally to computer systems, and more particularly, to a system and method for modeling business processes.

### OVERVIEW

Business process analysis is becoming an increasingly important activity for organizations. For example, an organization may perform business process analysis to design new processes that fit the needs of the organization, identify shortcomings, and increase efficiency. However, the majority of business processes are undocumented. Those business processes that are documented often fail to provide enough insight as to where the business processes can be enhanced.

### SUMMARY

According to one embodiment of the disclosure, a computerized method for modeling business processes includes receiving, at a computer, interaction data for interaction sessions. The interaction data includes session states indicative of session screens. The interaction data further includes transitions between the session states. The computerized method also includes identifying, at the computer, business processes based on the interaction data. The computerized method further includes identifying, at the computer, instances of the business processes in the interaction data. The computerized method further includes storing the instances as event records. The event records include a parameter indicative of a corresponding business process. The computerized method further includes generating a model based on the event records.

Technical advantages of particular embodiments of the present disclosure include the ability to model and analyze business processes from one or more sources of interaction data. For example, the present disclosure may be used with many different sources of interaction data such as session based systems, log files, and message streams.

Another technical advantage of particular embodiments of the present disclosure includes automatic detection of business processes. For example, screens encountered during an interaction session may be grouped into suggested business processes. Thus, a user may be presented with suggested business processes for a given set of interaction data automatically or on request.

Another technical advantage of particular embodiments of the present disclosure includes the ability to generate analytics and statistics based on identified business processes. For example, the collected interaction data may be used to generate a model that may be refined with filtering criteria, arranged according to various perspectives, and supplemented with business process statistics.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1A is a block diagram illustrating a system for modeling business processes in accordance with one embodiment of the disclosure;

FIG. 1B is a block diagram illustrating an example server system of the system of FIG. 1A in accordance with one embodiment of the disclosure;

FIG. 2 is a block diagram illustrating an example interaction session in accordance with one embodiment of the disclosure;

FIG. 3A is a diagram illustrating an example database table for storing event records in accordance with one embodiment of the disclosure;

FIG. 3B is a block diagram illustrating example models based on the data in the table of FIG. 3A in accordance with one embodiment of the disclosure; and

FIG. 4 is a flow diagram illustrating example acts associated with a computerized method for modeling business processes in accordance with one embodiment of the disclosure.

### DESCRIPTION OF EXAMPLE EMBODIMENTS

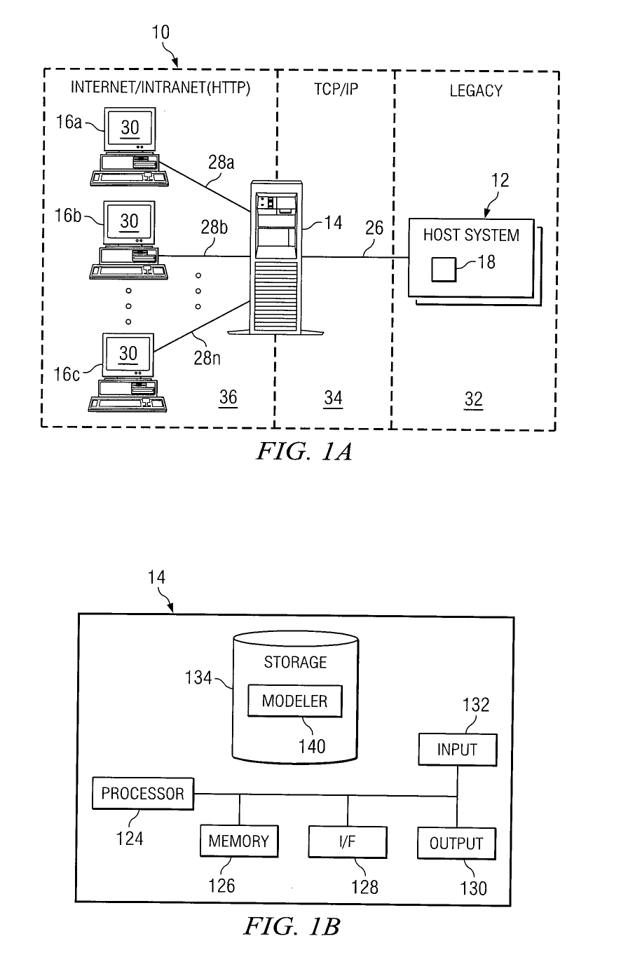

Embodiments of the present disclosure and its advantages are best understood by referring to FIGS. 1 through 4 of the drawings, like numerals being used for like and corresponding parts of the various drawings.

FIG. 1 illustrates an example system 10 for modeling business processes in accordance with one embodiment of the disclosure. System 10 may include one or more host systems 12, a server system 14, and one or more agent systems 16. Although an example implementation of system 10 is illustrated and primarily described, the present disclosure contemplates any suitable implementation of system 10. System 10 is particularly adapted for modeling business processes identified in interaction sessions between agent systems 16 and host systems 12. Examples of host systems 12, server system 14, and agent systems 16 are described in pending U.S. application Ser. No. 11/553,890 entitled “Modeling Interactions With a Computer System” filed Oct. 27, 2006, which is incorporated by reference herein.

An interaction session may include any interaction between agent systems 16 and host systems 12. According to one embodiment of the disclosure, an interaction session may include communication of one or more input screens by agent system 16, communication of one or more output screens by host systems 12, one or more action keys engaged by agent system 16, communication of data input in an input screen by an agent system 16, communication of data output in an output screen by host systems 12, or any other suitable interaction between agents system 16 and host systems 12.

According to one embodiment, an interaction session may include one or more session states and one or more transitions. A session state may include a condition of a computing system (or an application of a computing system). The computing system may transition from session state to session state according to input data received by the computing system and output data generated by the computing system. The session states encountered during an interaction session may be defined as the one or more screens encountered during the interaction session, along with any other suitable information. For greater specificity, the session states encountered during an in interaction session may be defined as the one or more screens encountered during the interaction session, including any data input or output into the screen. A transition from a session state may be caused by an action key engaged from a screen. For example, an action key could include an “Enter” key, a “Submit” key, a “Confirm” key, or any other suitable type of action key.

In various embodiments of the disclosure, during an interaction session, an agent system 16 may encounter a series of screens that are related to a particular business process. Identifying these business processes, however, can sometimes be problematic. Generally, many organizations do not document their business processes. Those organizations that do document their business processes do not generate detailed documents regarding their business processes. Thus, one main challenge with a session-based system is that there is no clear mapping between interaction data and appropriate business processes.

According to one embodiment of the disclosure, a system and method are provided for generating a model of business processes. This is effected, in one embodiment, by receiving interaction data between agent systems 16 and host systems 12 at server system 14. This collected interaction data may be analyzed and used to generate a model that may be refined with filtering criteria, arranged according to various perspectives, and supplemented with business process statistics. Additional details of components of FIG. 1A are provided below.

Host systems 12 may refer to a legacy computer system, such as a mainframe computer system. For example, host systems 12 may include one or more IBM mainframes (MVS, VM, and VSE environments), IBM AS/400 systems, UNIX host systems, or any other type of computing system. Host systems 12 may include one or more suitable input devices, output devices, mass storage media, processing units, memory units, or other components for receiving, processing, storing, and communicating information according to the operation of system 10. For example, host systems 12 may include one or more computers at one or more locations. The present disclosure contemplates host systems 12 being any suitable type of computer system, according to particular needs. Moreover, throughout the remainder of this description, host systems 12 will be referred to primarily in the singular; however, the present disclosure contemplates system 10 including any suitable number of computer systems 12.

Host system 12 may include one or more applications 18. Typically, applications 18 associated with host system 12 are legacy applications. For example, these legacy applications may include business logic for performing various transactions by interacting with users of application 18 (e.g., users of agent systems 16, as will be described more fully below). The present disclosure contemplates applications 18 performing any suitable functions and serving any suitable purpose according to particular needs. For example, application 18 may be a banking application that provides one or more banking functions, such as retrieving account information, modifying account information, or any other suitable banking functions.

Applications 18 may include any suitable combination of hardware, software, and firmware, according to particular needs. Applications 18 may be written in any suitable programming language. According to one embodiment of the disclosure, applications 18 may include computer software written in COBOL or another suitable programming language used for legacy applications. Throughout the remainder of this description, applications 18 will be referred to primarily in the singular; however, the present disclosure contemplates host system 12 including any suitable number of applications 18.

System 10 may include server system 14, which may be coupled to host system 12 and agent systems 16. For example, server system 14 may be coupled to host system 12 via a link 26 and may be coupled to agent systems 16 via links 28a-28n. Links 26 and 28 may each include one or more local area networks (LANs), metropolitan area networks (MANs), wide area networks (WANs), radio access networks (RANs), a global computer network such as the Internet, or any other wireline, optical, wireless, or other links. Links 26 and 28 may communicate, for example, Internet Protocol (IP) packets, Frame Relay frames, or Asynchronous Transfer Mode (ATM) cells to communicate voice, video, data, and other suitable information between network addresses. Link 26 may include any suitable type of connection for communicating with host system 12, such as a transmission control protocol (TCP)/Internet Protocol (IP) connection. Additionally, links 28 may include any suitable type of connection for communicating with agent systems 16, such as for communicating Hypertext Transfer Protocol (HTTP) over the Internet/Intranet. According to one embodiment of the disclosure, any number of intervening servers may exist between server system 14 and host system 12, as well as between server system 14 and agent systems 16.

In general, server system 14 provides an interface between host system 12 and agent systems 16. For example, server system 14 may facilitate communication between agent systems 16 and host system 12, providing agent systems 16 with access to host system 12 and/or applications 18 of host system 12. According to one embodiment of the disclosure, server system 14 includes a web server and/or an emulation server; however, the present disclosure is not limited to server system 14 being a web server and/or an emulation server. As just two examples, server system 14 may include a WEBCONNECT server or a SLICONNECT server, both manufactured by OPENCONNECT SYSTEMS, INC.

Agent systems 16 may include any entity or process that interacts with host system 12 and/or application 18 through a predefined input and/or output interface. For example, agents may include users of agent systems 16 or applications of agent systems 16. Agent system 16 and agent or user of agent system 16 may be referred to interchangeably throughout this description.

Agent systems 16 may each include one or more computers at one or more locations and may share data storage, communications, or other resources according to particular needs. For example, functionality described in connection with agent system 16 may be provided using a single computer system, which in a particular embodiment might include a conventional desktop or laptop computer. Furthermore, functionality described in connection with agent systems 16 may be provided using any suitable software components. Each computer system may include one or more suitable input devices, output devices, mass storage media, processing units, memory units, or other components for receiving, processing, storing, and communicating information according to the operation of system 10. Although a particular number of agent systems 16 are illustrated, the present disclosure may include any suitable number of agent systems 16. Each agent system 16 may operate using a different user platform, or two or more agent systems 16 may operate using identical user platforms.

According to one embodiment of the disclosure, agent systems 16 may each include an interface 30 for facilitating transmission and receipt of data over link 28. For example, interface 30 may include a generic web browser, such as MICROSOFT INTERNET EXPLORER, NETSCAPE NAVIGATOR, or any other suitable browser. In other embodiments, interface 30 need not be an Internet browser but may include any suitable network browser or other interface. Each agent system 16 may interact with application 18 of host system 12 (through server system 14) using its corresponding interface 30.

According to one embodiment of the disclosure, host system 12 is part of a legacy environment 32, server system 14 interacts with host system 12 in a TCP/IP environment 34 (e.g., using one or more TCP/IP links 26), and agent computer systems 16 interact with server system 14 in an Internet/Intranet environment 36 (e.g., using a standard user interface language such as Hypertext Markup Language (HTML) and a standard protocol such as Hypertext Transfer Protocol (HTTP)). For example, server system 14 may accept input from agent systems 16 via a web browser and return appropriate HTML pages. Server system 14 may provide an interface between TCP/IP environment 34 and Internet/Intranet environment 36. In various embodiments, agent interaction includes a user or system interacting with the mainframe application through, for example, a TN3270 data terminal interface. Thus, in certain embodiments, server system 14 provides a terminal emulation function in order to provide an interface to applications 18 over a network such as the Internet or an Intranet. It should be understood that these environments are provided merely as examples; the present disclosure contemplates system 10 including any suitable numbers and types of environments, and the components of system 10 being coupled using any suitable types of connections, according to particular needs.

During an interaction session, application 18 of host system 12 communicates screens to server system 14 in a particular format. The particular format for communication between host system 12 and server system 14 may depend on the type of host system 12 used in system 10. As examples, data exchanged between host system 12 and server system 14 may be TN3270 data, TN5250 data, enterprise extender data, or data in another suitable format. Throughout the remainder of this description, the data format communicated between host system 12 and server system 14 will be referred to as a terminal format. The screens communicated by host system 12 may also include output data generated by host system 12. For example, the output data may include data in one or more fields of a screen transmitted by host system 12 to agent system 16.

Server system 14 may receive the screens and the output data communicated by host system 12 and may perform certain data transformations on those screens. For example, server system 14 may transform the screens into a different format that is displayable in interface 30 of agent systems 16 (e.g., HTML, XML, or another suitable format). Server system 14 may also receive screens and input data from agent systems 16 and may perform certain data transformations on those screens such that host system 12 can process the screens and the input data.

In operation of an example interaction session in an example embodiment of system 10, agent system 16 may use interface 30 to initiate an interaction session by logging onto host system 12 via server system 14. Assume, for purposes of this example, that application 18 is the banking application described above. In response to a successful login, host system 12 may communicate a screen to server system 14. This screen may be a default screen displayable after a successful login, specified in the login request by agent system 16, or any other suitable screen, according to particular needs. For example, the screen may be a summary screen for the bank account of agent system 16. Server system 14 may receive the screen and any output data in the terminal format. Server system 14 may convert the terminal data into a format displayable by interface 30 of agent system 16. For example, the summary screen may be displayed by interface 30 on agent system 16 as a web page. Agent system 16 may input data into the screen. For example, agent system 16 may input data to request an account balance. Agent system 16 may submit this input data, along with the current screen, to server system 14.

Server system 14 may process the screen and input data submitted by agent system 16 and convert that data into a format that may be processed by application 18 of host system 12. Host system 12 may process the screen and the input data. In this example, host system 12 may attempt to fulfill the account balance request submitted by agent system 16. Server system 14 may transform the output screen and output data received from host system 12 into a format displayable by interface 30 of agent system 16. This process may iterate as many times as is appropriate. Thus, server system 14 may be viewed as a translator between environments (e.g., between TCP/IP environment 34 and Internet/Intranet environment 36).

FIG. 1B is a block diagram illustrating an example server system 14 of the system of FIG. 1A in accordance with one embodiment of the disclosure. According to the illustrated embodiment of the disclosure, server system 14 includes a processor 124, a memory 126, a communication interface (I/F) 128, an output device 130, an input device 132, a storage device 134, and a modeler 140.

According to one embodiment of the disclosure, modeler 140 refers to any suitable hardware and/or software operable to receive interaction data for interaction sessions between agent systems 16 and host system 12 and generate a model based on the interaction data. Interaction data received by modeler 140 may include raw data streams of selections made by an agent system 16, data entered into a screen by an agent system 16, data gathered by parsing the screens passed between agent system 16 and host system 12, display information, application 18 flow information, action keys, or any other suitable information. Modeler 140 may store received interaction data in any suitable storage medium at any suitable location.

Modeler 140 is operable to analyze received interaction data regarding interaction sessions to identify business processes, according to one embodiment of the disclosure. In one embodiment, modeler 140 may identify business processes by automatically grouping session states encountered during an interaction session. In the embodiment, the underlying computer system may be modeled as one or more session states and transitions in the form of a navigation model. For example, the navigation model may include a finite state machine model of the underlying computer system, generated through similar collection and analysis of interaction information of interaction sessions with the computer system. In the example, modeler 140 may identify business processes by automatically grouping session states in the navigation model. Modeler 140 may group session states by creating a transition list that excludes any transitions currently identified in a business process and sorting these transitions based on a usage count. Modeler 140 may start with the highest use transition and identify a source and destination state associated with the transition. Next, modeler 140 may include all transitions from the destination states and to the source state where the usage of the transitions is higher than a threshold value. For each included transition, the process may be repeated to identify other transitions to include until no further thresholds meet the threshold criteria. The included transitions and their associated states may be grouped together as a business process by modeler 140. However, the present disclosure contemplates many techniques for identifying business processes. Various embodiments may include some, all, or none of the enumerated techniques.

Modeler 140 is operable to identify instances of the business processes in the interaction data and store the instances as event records, according to one embodiment of the disclosure. Event records may include one or more parameters such as a parameter indicative of event record ID, a parameter indicative of a corresponding business process, and a parameter indicative of a timestamp. Modeler 140 may store the event records in any suitable storage medium at any suitable location.

According to one embodiment of the disclosure, modeler 140 is operable to generate a model based on the event records. For example, modeler 140 may generate a perspective view of the event records based on a primary parameter of the event records, also referred to as a primary tag or object identification. Modeler 140 may generate a perspective view of the model by generating a composite model by combining the individual event record transitions for each value of the tag identification.

Modeler 140 is operable to filter the generated model based on other tag identifications, according to one embodiment of the disclosure. For example, the user may engage in a workflow of examining the model, interrogating the exceptions, and refining the process selection through the application of filtering criteria. This filtering criteria may include, for example, a filter based on based on an event record timestamp, a filter based on subsets of values for the primary tag identification, and a filter based on subsets of values for secondary tag identifications.

According to another embodiment of the disclosure, modeler 140 is operable to provide a report regarding a specific event record transition and provide the frequency, distribution of timing, and top values for any secondary tag for the transition. In other embodiments, modeler 140 may also provide a report regarding all values for any tag value for a transition, all values for any tag value for any process (all events that visited that process), and event duration, for a single business process (the duration of and distribution of time for the event record).

According to one embodiment of the disclosure, modeler 140 is operable to suggest subsets of event record transitions and supporting rules based on other tag identification values. For example, in a simple business process of customer shopping, 78% of customers may repeat purchases where 6% of those purchases are returns. In the example, modeler 140 may identify a subset of customers that return virtually every purchase. Modeler 140 may use various techniques to identify subsets of event record transitions such as optimization and clustering operations, including clustering based on perspective attribute value, clustering individual event transitions, or any other suitable technique.

According to one embodiment of operation, a user may select a perspective view to create a model based on a primary tag and a set of secondary tags using modeler 140. Modeler 140 may automatically suggest subsets of event record transitions and supporting rules based on other tag identification values. The user may perform a discovery operation using modeler 140 to discover process variations. For example, the user may be able to discover process variations based on various factors such as similar primary tags, similar event transitions, or statistical measures.

If a user selects to group similar event transitions, for example, the user may be prompted for how many groups (k) to create, and then modeler 140 may proceed to create (k) groupings of event transitions and draw the resulting business processes model for each variation. Modeler 140 may then invoke a clustering operation to generate a set of sub-models. For example, modeler 140 may generate the set of sub-models with a distance metric by computing, for each transition of sub-models A and B, a distance between a transition Ta and a transition Tb and summing the individual distances to compute the total distance between sub-models A and B. The next step of the clustering operation would then take the sub-models and try to determine a rule that results in the classification of the event-transitions into each cluster. Further analysis may involve using a standard decision tree approach to determine rules that relate to feature set values that lead consistently to classification to one of the clusters.

Thus, embodiments of the present invention identify business processes and instances of the business processes in the interaction data. Analytics based on identified business processes are provided and the analytics may be used to generate a model of the business processes based on the interaction data. The model may be refined with filtering criteria, arranged according to various perspectives, and supplemented with business process statistics. Additional details of the other components of server system 14 are described below.

Processor 124 may refer to any suitable device operable to execute instructions and manipulate data to perform operations for server system 14. Processor 124 may include, for example, any type of central processing unit (CPU).

Memory 126 may refer to any suitable device operable to store and facilitate retrieval of data. Memory 126 may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Communication interface (I/F) 128 may refer to any suitable device operable to receive input for server system 14, send output from server system 14, perform suitable processing of the input or output or both, communicate to other devices, or any combination of the preceding. Communication interface 128 may include appropriate hardware (e.g. modem, network interface card, etc.) and software, including protocol conversion and data processing capabilities, to communicate through a LAN, WAN, or other communication system that allows server system 14 to communicate to other devices. Communication interface 128 may include one or more ports, conversion software, or both.

Output device 130 may refer to any suitable device operable for displaying information to a user. Output device 130 may include, for example, a video display, a printer, a plotter, or other suitable output device.

Input device 132 may refer to any suitable device operable to input, select, and/or manipulate various data and information. Input device 132 may include, for example, a keyboard, mouse, graphics tablet, joystick, light pen, microphone, scanner, or other suitable input device.

Storage device 134 may refer to any suitable device operable for storing data and instructions. Storage device 134 may include, for example, a magnetic disk, flash memory, optical disk, or other suitable data storage device.

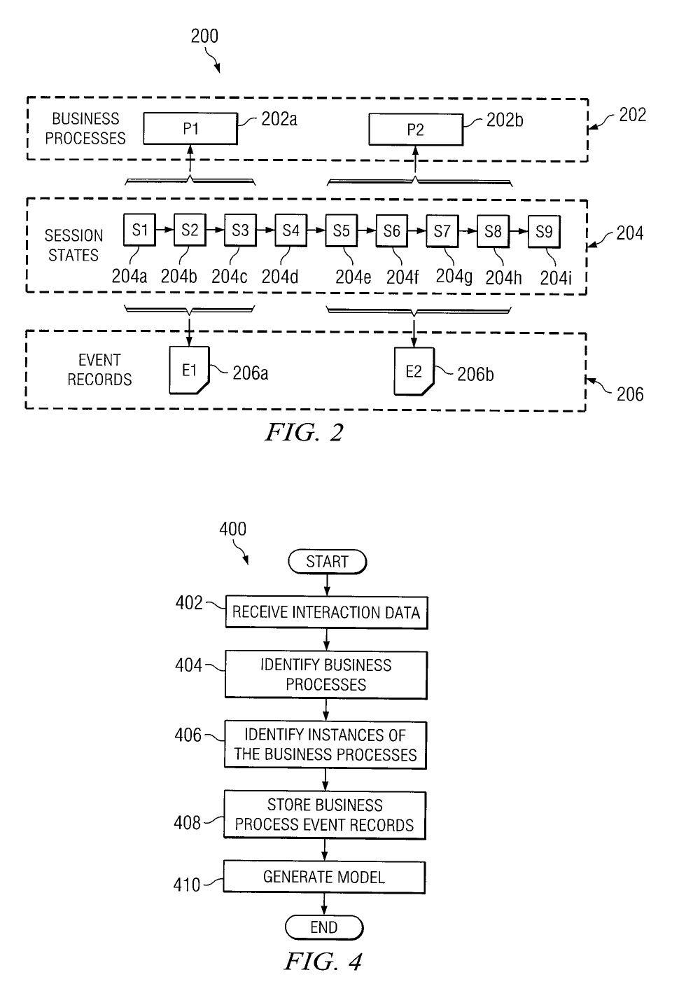

FIG. 2 is a block diagram illustrating an example interaction session 200 in accordance with one embodiment of the disclosure. As shown in FIG. 2, interaction session 200 generally includes business processes 202, session states 204, and event records 206. Although the illustrated embodiment includes two identified business processes P1 202a and P2 202b, the present disclosure contemplates identifying many types of business processes.

According to the illustrated embodiment, business processes P1 202a and P2 202b may be identified using any suitable technique. For example, session states 204 may be arranged in the form of a navigation model. The navigation model may include a finite state machine model of the underlying computer system, generated through similar collection and analysis of interaction information of interaction sessions with the computer system. As described above, business processes may be identified by automatically grouping particular session states in the navigation model. In the illustrated embodiment, business process P1 202a is identified as a grouping of session states S1 204a, S2 204b, and S3 204c while business process P2 202b is identified as a grouping of session states S5 204e, S6 204f, S7 204g, and S8 204h.

As another example, in various embodiments, some systems may not have appropriately tagged fields and screens, and therefore it may be difficult to determine session states 204 that make up a particular business process. In these embodiments, analytics on the documents representing the screen presented to the user in a particular session state 204 may be performed to identify business processes based on similar documents and fields. However, the present disclosure contemplates many techniques for identifying business processes. Various embodiments may include some, all, or none of the enumerated techniques.

According to one embodiment of the disclosure, instances of the identified business processes in the interaction data are identified and stored as event records 206. In the illustrated embodiment, event record E1 206a is associated with business process P1 202a and event record E2 is associated with business process P2 202b. In one embodiment, event records 206 may include one or more parameters such as a parameter indicative of event record ID, a parameter indicative of a corresponding business process, and a parameter indicative of a timestamp. Event records 206 may be stored in any suitable storage medium at any suitable location.

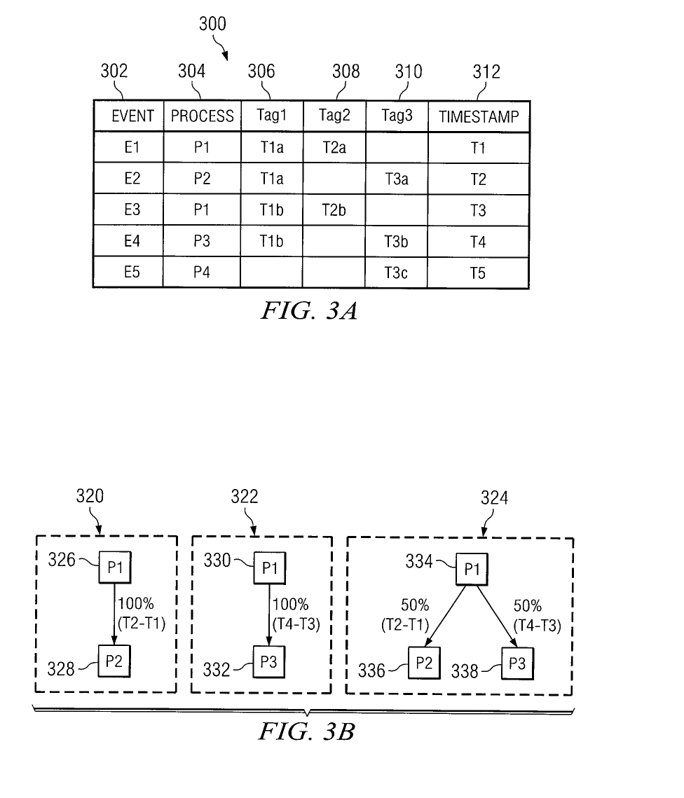

FIG. 3A is a diagram illustrating an example database table 300 for storing event records in accordance with one embodiment of the disclosure. In the embodiment, a row of data, referred to as a record in this disclosure, in table 300 represents a single event record. In the illustrated embodiment, each event record includes a parameter indicative of an event record ID 302, a parameter indicative of a corresponding business process 304, one or more parameters indicative of tags of the business process 306, 308, and 310, and a parameter indicative of a timestamp 312. In other embodiments of the present disclosure, parameters 302, 304, 306, 308, 310, and 312 may reside in a single column or any other suitable table design.

According to one embodiment of the disclosure, the parameter indicative of the event record ID 302 may include a row number for each record, and may be chronologically sequential with regard to entries made in table 300. The parameter indicative of the event record ID 302 may be a primary key for table 300. That is, the parameter indicative of the event record ID 302 may uniquely identify the records in table 300.

According to one embodiment of the disclosure, the parameter indicative of a corresponding business process 304 may include an associated business process. For example, Event E1 of table 300 is associated with identified Process P1 and Event E2 is associated with identified Process P2.

According to one embodiment of the disclosure, one or more parameters indicative of tags of the business process 306, 308, and 310 may include characteristics of the event record. For example, Tag1 306 may include revenue of a business process. In the illustrated embodiment, Event E1 resulted in revenue represented as value “T1a” of Tag1 306. As another example, Tag2 308 may include a user of a business process. In the illustrated embodiment, Event E1 was run by a user represented as value “T2a” of Tag2 308. In other embodiments, parameters 306, 308, and 310 may include any other suitable characteristics of the event record.

According to one embodiment of the disclosure, the parameter indicative of a timestamp 312 includes date/time data for each record. In one embodiment, the parameter indicative of a timestamp 312 may store a date/time entry in the format “DD.MM.YYYY HH:NN:SS” where “DD” refers to day, “MM” refers to month, “YYYY” refers to year, “HH” refers to hour, “NN” refers to minute, and “SS” refers to second. In other embodiments, the parameter indicative of a timestamp 312 may store date/time information in other formats.

Accordingly, the present disclosure contemplates many types of records to represent event record data. Various embodiments may include some, all, or none of the enumerated data. In short, table 300 is defined to hold various types of rows and columns relating to event records.

FIG. 3B is a block diagram illustrating example models 320, 322, and 324 based on the data in table 300 of FIG. 3A in accordance with one embodiment of the disclosure. In the illustrated embodiment, a user has selected the perspective of Tag1 306 as the primary tag. Thus, the Events E1-E4 are used to generate models 320, 322, and 324. Event E5 is not used because Event E5 does not include a value for Tag1 306.

Model 320 represents Event E1 and E2 from table 300 and the corresponding transition from Process P1 326 of Event E1 and Process P2 328 of Event E2. Processes P1 326 and P2 328 are linked by the value “T1a” of Tag1 306. Model 322 represents Event E3 and E4 from table 300 and the corresponding transition from Process P1 330 of Event E3 and Process P3 332 of Event E4. Processes P1 330 and P3 332 are linked by the value “T1b” of Tag1 306. Model 324 represents the combined models of 320 and 322. Processes P1 334, P2 336, and P3 338 are linked by the values “T1a” and “T1b” of Tag1 306 for Events E1-E4.

The statistics shown on models 320, 322, and 324 are the percentage of time the event transition happens and the average time between events. Models 320, 322, and 324 may display other statistics based on user-selected tags for display. For example, Tag2 308 may represent a cost of a business process. If the user selects Tag2 308 as a secondary tag for display, the associated model may also display the average cost of events that are transitioning based on Tag2 308 values. In general, the perspective of the model is based on the primary tag, and statistics indicative of a set of secondary tags may be displayed on the model.

FIG. 4 is a flow diagram 400 illustrating example acts associated with a computerized method for modeling business processes in accordance with one embodiment of the disclosure. The example acts may be performed by modeler 140, as discussed above with reference to FIG. 1A, or by any other suitable device. At step 402, interaction data is received at a computer for interaction sessions. The interaction data may include session states indicative of session screens and transitions between the session states. In one embodiment, the interaction data may include a navigation model that includes a finite state machine generated through collection and analysis of interaction information.

At step 404, business processes based on the interaction data are identified at the computer. In one embodiment, business processes may be identified by automatically grouping session states in the navigation model. However, the present disclosure contemplates many techniques for identifying business processes. Various embodiments may include some, all, or none of the enumerated techniques.

At step 406, instances of the business processes in the interaction data are identified at the computer. At step 408, the instances are stored as event records at the computer. In one embodiment, the event records may include one or more parameters such as a parameter indicative of an event record ID, a parameter indicative of a corresponding business process, and a parameter indicative of a timestamp. The event records may be stored in any suitable storage medium at any suitable location.

At step 410, a first model based on the plurality of event records is generated at the computer. For example, a perspective view of the event records may be generated by selecting a primary tag and combining the individual event record transitions for each value of the tag identification. The user may then engage in a workflow of examining the generated model, interrogating the exceptions, and refining the process selection through the application of filtering criteria.

Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as falling within the spirit and scope of the appended claims.

What is claimed is:

1. A computerized method for modeling business processes, comprising:
receiving, at a computer, interaction data for a plurality of interaction sessions, the interaction data comprising a plurality of session states indicative of a plurality of session screens, the interaction data further comprising a plurality of transitions between the plurality of session states;
identifying, at the computer, a plurality of business processes based on the interaction data;
identifying, at the computer, a plurality of instances of the business processes in the interaction data;
storing the plurality of instances as a plurality of event records, the plurality of event records comprising a parameter indicative of a corresponding business process; and
generating a first model based on the plurality of event records.

2. The computerized method of claim 1, wherein generating a first model based on the plurality of event records comprises generating a perspective view of the first model by selecting a particular parameter of the plurality of event records.

3. The computerized method of claim 1, wherein identifying a plurality of business processes in the interaction data comprises grouping a plurality of session states.

4. The computerized method of claim 1, wherein the plurality of event records further comprises a parameter indicative of an event record ID and a parameter indicative of a timestamp.

5. The computerized method of claim 1, wherein each of the plurality of session states corresponds to a screen encountered during the plurality of interaction sessions.

6. The computerized method of claim 1, wherein receiving interaction data for a plurality of interaction sessions comprises receiving a second model of the interaction data.

7. The computerized method of claim 1, wherein generating a first model based on the plurality of event records comprises generating the first model based on a subset of the plurality of event records.

8. The computerized method of claim 1, wherein generating a first model based on the plurality of event records comprises identifying one or more related event records.

9. The computerized method of claim 1, wherein the first model further comprises one or more statistics for the plurality of event records.

10. A system for modeling business processes, comprising:
a processor; and
a storage device embodying a program of instructions operable, when executed on the processor, to:
receive interaction data for a plurality of interaction sessions, the interaction data comprising a plurality of session states indicative of a plurality of session screens, the interaction data further comprising a plurality of transitions between the plurality of session states;
identify a plurality of business processes based on the interaction data;
identify a plurality of instances of the business processes in the interaction data;
store the plurality of instances as a plurality of event records, the plurality of event records comprising a parameter indicative of a corresponding business process; and
generate a first model based on the plurality of event records.

11. The system of claim 10, wherein the program of instructions is further operable to generate a perspective view of the first model by selecting a particular parameter of the plurality of event records.

12. The system of claim 10, wherein the program of instructions is further operable to group a plurality of session states.

13. The system of claim 10, wherein the plurality of event records further comprises a parameter indicative of an event record ID and a parameter indicative of a timestamp.

14. The system of claim 10, wherein each of the plurality of session states corresponds to a screen encountered during the plurality of interaction sessions.

15. The system of claim 10, wherein the program of instructions is further operable to receive a second model of the interaction data.

16. The system of claim 10, wherein the program of instructions is further operable to generate the first model based on a subset of the plurality of event records.

17. The system of claim 10, wherein the program of instructions is further operable to identify one or more related event records.

18. The system of claim 10, wherein the first model further comprises one or more statistics for the plurality of event records.

19. Logic encoded in computer-readable media, the logic being operable, when executed on a processor, to:
receive interaction data for a plurality of interaction sessions, the interaction data comprising a plurality of session states indicative of a plurality of session screens, the interaction data further comprising a plurality of transitions between the plurality of session states;
identify a plurality of business processes based on the interaction data;
identify a plurality of instances of the business processes in the interaction data;
store the plurality of instances as a plurality of event records, the plurality of event records comprising a parameter indicative of a corresponding business process; and
generate a first model based on the plurality of event records.

20. The logic of claim 19, wherein the logic is further operable to generate a perspective view of the first model by selecting a particular parameter of the plurality of event records.

21. The logic of claim 19, wherein the logic is further operable to group a plurality of session states.

22. The logic of claim 19, wherein the plurality of event records further comprises a parameter indicative of an event record ID and a parameter indicative of a timestamp.

23. The logic of claim 19, wherein each of the plurality of session states corresponds to a screen encountered during the plurality of interaction sessions.

24. The logic of claim 19, wherein the logic is further operable to receive a second model of the interaction data.

25. The logic of claim 19, wherein the logic is further operable to generate the first model based on a subset of the plurality of event records.

26. The logic of claim 19, wherein the logic is further operable to identify one or more related event records.

27. The logic of claim 19, wherein the first model further comprises one or more statistics for the plurality of event records.

28. A method for modeling business processes, comprising:
receiving interaction data for a plurality of interaction sessions, the interaction data comprising a finite state machine model, the finite state machine model comprising a plurality of session states indicative of a plurality of session screens, the interaction data further comprising a plurality of transitions between the plurality of session states; and
identifying a plurality of business processes in the finite state machine model.

29. A method for modeling business processes, comprising:
receiving interaction data for a plurality of interaction sessions, the interaction data comprising a plurality of session states indicative of a plurality of session screens, the interaction data further comprising a plurality of transitions between the plurality of session states;
identifying a plurality of business processes based on the interaction data;
identifying a plurality of instances of the business processes in the interaction data;
storing the plurality of instances as a plurality of event records, the plurality of event records comprising a parameter indicative of a corresponding business process; and
generating a first model based on the plurality of event records.
